(19) United States
(12) Patent Application Publication
(10) Pub. No.: US 2005/0102894 A1
(43) Pub. Date: May 19, 2005

(54) Modular tutor system having lights

(76) Inventor: Lapierre Jocelyn, Shawinigan (CA)

Correspondence Address: INVENTARIUM, Suite 1607, 4050 Rosemont blvd, Montreal, QC, H1X 1M4, CA

(21) Appl. No.: 10/991,645

(22) Filed: Nov. 18, 2004

Related U.S. Application Data
(60) Provisional application No. 60/523,223, filed on Nov. 18, 2003.

(51) Int. Cl. A01G 9/12

(52) U.S. Cl. 47/47

(57) ABSTRACT

A modular tutor system having lights has a base having a series of holes made into it. Any one of those holes can receive a tutor assembly since some species of plants may require more than one tutor to fully support it as it grows. The tutor assembly itself is made out of segments which can extend the length of the tutor assembly according to need. Holes in the base as well as in the tutor assembly help drain water. The tutor assembly has a series of connecting holes to receive horizontal support arms as well as DC power outlets to power up small lighting fixtures. The horizontal support arms are used for propping up branches and leaves as well as for holding teh lighting fixtures.

This application claims priority based on provisional application 60/523,223 filed Nov. 18, 2003

### BACKGROUND OF THE INVENTION

1. Field of the Invention

The invention relates generally to plant supports but more particularly to a plant tutor system having interconnected modules a base and decorative lighting fixtures.

2. Background of the Invention

The use of sticks to help prop-up plants has been known for years and there are a number of inventions describing various types of shafts or poles or sticks, some are directed at interior potted plants while others are directed at exterior in-ground plants.

For example, U.S. Pat. No. 4,048,752 shows a multisectional support useful as a trellis and for other purposes. Each section includes one or more components to which the corresponding components of super- and/or subjacent sections can be assembled and a supporting member attached to and surrounding the first-mentioned components.

U.S. Pat. No. 5,335,448 shows a method and device for supporting plants involving a stake which includes a hollow tube made of polyvinylchloride and metal supporting wires directed axially and distributed around the circumference of the wall of the tube. Preferably, the hollow tube is formed with individual conduits running in an axial direction along or within the tube wall, each of which contains one of the wires and an adhesive material to hold the wires in place.

U.S. Pat. No. 5,341,593 shows a small spring steel stake used to support a large tomato plant. The plant is held close to the stake so that the stake supports the plant with its weight pulling substantially straight down along the axis of the stake. Rings are optionally used to support only the branches and not the stem of the plant. Since the tomatoes grow close to the stem, a heavy load of tomatoes adds little weight to the rings. A shade, designed to be installed whenever the gardener decides the time is right, is detachably mounted to the top of the plant support and consists of spaced apart shade members so that rain water captured by the shade members may be directed to the roots of the plant. An optional deck planter adapted to secure the stake in its vertical position facilitates the use of the plant support for urban and even indoor gardening conditions.

U.S. Pat. No. 5,879,071 shows a lighted planter including a container having a bottom and side walls and an opening formed by the walls and spaced from the bottom wall. The side walls include a generally horizontally extending edge portion adjacent the opening and a light source integral with the edge portion providing upwardly projecting illumination to directly light a plant planted therein.

U.S. Pat. No. 6,234,444 shows a plant supporter utilizing a pole having lugs attached to it. Apertures extend into each lug and cantilevered arms extend from the apertures outwardly from the pole to provide support to a plant. The lugs may have a resilient clip portion such that they may be easily mounted or removed from the pole.

U.S. Pat. No. 6,282,836 shows an adjustable support system for trees for stabilizing limbs and a trunk of a tree. The system includes a stake portion having a tapered lower end and a planar upper end. The tapered lower end penetrates a recipient surface adjacent to a tree. A support pole couples with the planar upper end of the stake portion. A plurality of support collars are slidably coupled with the upper section of the support pole. Each of the support collars have a peripheral flange extending outwardly thereof. The peripheral flange has a plurality of circumferentially spaced apertures therethrough. A plurality of support cables are provided with each having inner ends securable to the apertures of the peripheral flange of the support collars. Outer ends of the support cables are looped with rubber hosing disposed thereon for engaging a tree limb.

These inventions do not provide for an integral base to hold a tutor in place. This feature is important for potted plants which may not have a lot of dirt weight or density to suitably hold a tutor. Also, some plants need additional support for their leaves and branches which does not require to be as extensive as that described in U.S. Pat. No. 6,282,836 above. Additionally, there is no comparable invention describing a simple and practical way of using a tutor to bring power to lighting fixtures as decorative elements to enhance the visual qualities of a plant.

### SUMMARY OF THE INVENTION

In view of the foregoing disadvantages inherent in the known devices now present in the prior art, the present invention, which will be described subsequently in greater detail, is to provide objects and advantages which are:

It is a first object of this invention to provide for a modular tutor system having a base.

It is a second object of this invention to provide for a modular tutor system having additional support for branches and leaves.

It is a third object of this invention to provide for a modular tutor system having integrated electrical wiring to provide power to lighting fixtures.

It is a fourth object of this invention to provide for a modular tutor system that is expandable and customizable.

To attain these ends, the present invention generally comprises a base having a series of holes made into it. Any one of those holes can receive a tutor assembly since some species of plants may require more than one tutor to fully support it as it grows. The tutor assembly itself is made out of segments which can extend the length of the tutor assembly according to need. Holes in the base as well as in the tutor assembly help drain water. The tutor assembly has a series of connecting holes to receive horizontal support arms as well as DC power outlets to power up small lighting fixtures. The horizontal support arms are used for propping up branches and leaves as well as for holding teh lighting fixtures.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

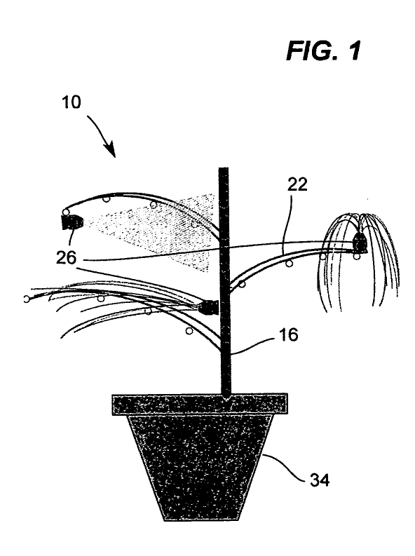

FIG. 1 Front elevation of the modular tutor system in a pot with horizontal stems and light fixtures.

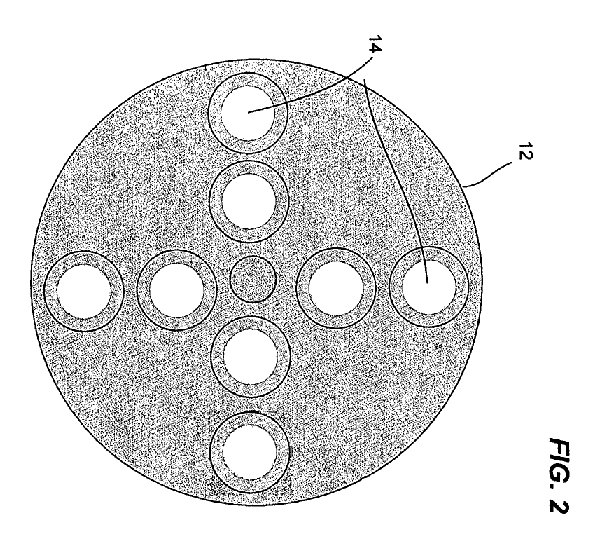

FIG. 2 Top elevation of the base plate showing a plurality of holes.

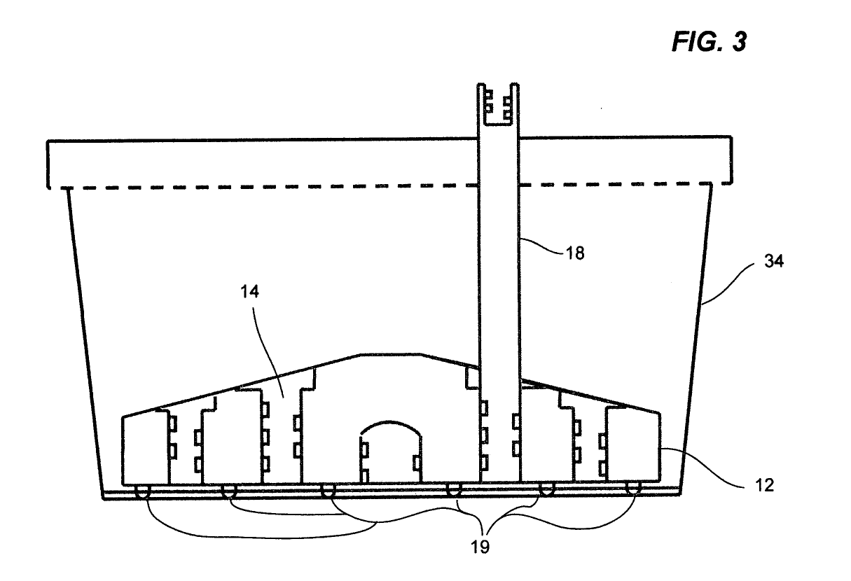

FIG. 3 Side cutaway view of the base plate inside a pot and with a segment of the tutor assembly.

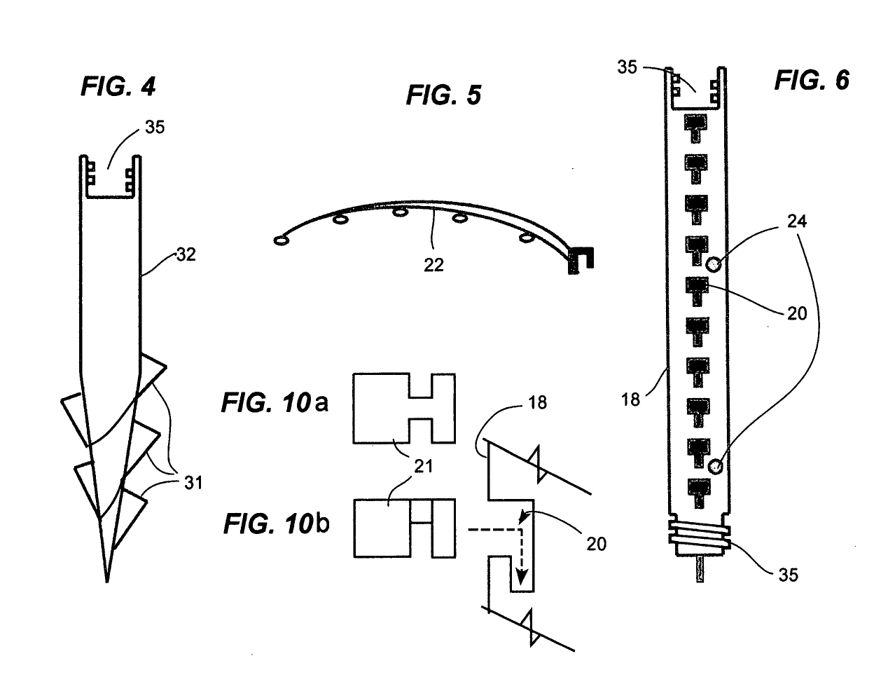

FIG. 4 Side elevation of a stake.

FIG. 5 Side elevation of a horizontal stem.

FIG. 6 Side elevation of a tutor assembly segment.

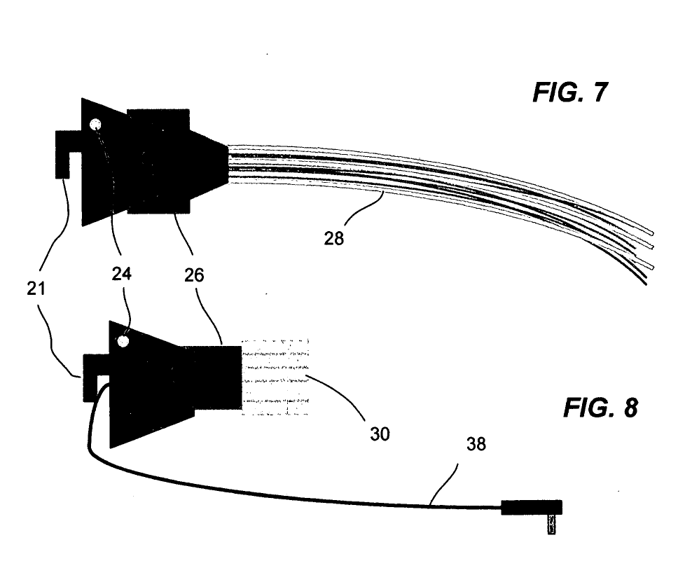

FIG. 7 Side elevation of the fiber optic lighting fixture.

FIG. 8 Side elevation of the LED lighting fixture.

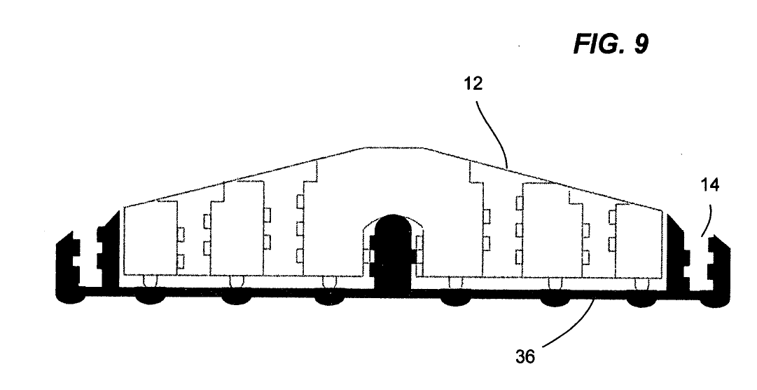

FIG. 9 Side cutaway elevation of an extension base plate.

FIG. 10a Top elevation of a tip.

FIG. 10b Side elevation of a tip along with a side elevation cutaway of a section of a segment.

### DETAILED DESCRIPTION OF THE PREFERRED EMBODIMENT

A modular tutor system (10) consists of a base plate (12); a tutor assembly (16), and horizontal stems (22).

The tutor assembly (16) consists of a plurality of tutor segments (18) with each segment (18) being connected to the next, both mechanically and electrically.

The mechanical connecting means, preferably but not necessarily being by way of threads which can be of the <<¼ turn>> kind or <<screw>> type threads, with the first segment being mechanically attached to any of a plurality of holes (14) made into the base plate (12). The first segment is usually threaded into one of a plurality of holes (14) in the base plate (12). The thread arrangement of the base plate (12) holes (14) is identical to that of the threads connecting the various segments (18) together for obvious compatibility reasons.

As for the electrical connection, it is by way of electrical connecting means, preferably but not necessarily male/female connectors (36, 36′) containing both polarities for carrying low voltage DC current as is well known in the art. This way, electricity can be carried from the first segment (18) connected to the base (12) all the way to the top end of the tutor assembly (16).

The horizontal stems (22) can be used to support branches but are also used to hold small lighting fixtures (26).

The holes (14) in the base plate (12) are not only to mechanically fasten one or more segments (18) but also serve as water drain so that the base plate (12) will not become a hindrance to the natural watering and draining process as normally occurs in a planting pot (34). For that purpose, little footings (19) are disposed underneath the base plate to lift it up. Dirt and roots are allowed to grow and fill the holes (14) and if the plant becomes too large for the original planting pot (34), by pulling on the tutor assembly (16), the base plate (12) comes with it and an extension base plate (36), into which can fit the base plate (12), is installed. The extension base plate (36) uses a similar mechanical connecting means as that of the segments (18) described earlier.

Also, it is preferable that the base plate (12) be made heavy by choice of materials such as resin covered pig iron or poured concrete inside a resins shell so that it can firmly hold a plant in place. Even though dirt covering up the base plate (12) and providing its own weight, sometimes a plant uses a light mixture of peat moss and other light growing medium which may not be capable of providing sufficient weight to hold down a lightweight base plate (12).

The tutor assembly (16) has a series of connecting holes (20) to receive the horizontal stems (22). These connecting holes (20) can also be used in the process of water drainage as water drainage means for the part of the tutor assembly (16) situated below ground level or even for when watering the plant leaves to gather any excess water. The connecting holes (20) are configured and sized to allow for the tip part (21) of the horizontal stems (22) or of the lighting fixtures (26), which are complementarily configured and sized to connect to the segment (18). This is done through any of various means with the means illustrated here, by way of example, as being a fairly standard push in push down fashion. Other means known in the art could also be substituted without departing from the scope of the invention. The lighting fixtures (26) can also be hung from any of a plurality of hooking loops (23) found on each horizontal stem (22). These hooking loops (23) serve to hook a power cord (38) from the lighting fixture (26), the lighting fixtures (26) themselves or to help hold branches by using the hooking loops (23) to tie to. The light fixtures (26) and the power cords (38) can be simply tied to the hooking loops (23) by strings or any other practical means known in the art.

The tutor assembly (16) also carries embedded wiring so that DC power outlets (24) can provide power to the lighting fixtures (26) which can come in various shapes and forms and can use fiber optics (28) or LEDs (30), or any combination thereof and have the little power cord (38) that connects into the DC power outlets (24).

A standard AC to DC step down transformer (not shown) can be plugged into any of the DC power outlets (24) to provide power to the entire tutor assembly (16). Each individuial light fixture (26) also has a DC power outlet (24) so that a plurality of additional light fixtures (26) can be connected daisy chain style.

For exterior use or when a base plate (12) is not necessarily needed, it can be replaced with a stake (32) planted directly into the ground to start up the tutor assembly (16). For better grip, the stake (32) can have stake threads (33).

In the case of pots (34), an extension base plate (36), into which can fit the base plate (12), is used when the diameter of the pot (34) is very large.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A modular tutor system comprising:
a base plate, a tutor assembly, and horizontal stems;
said tutor assembly comprised of a plurality of tutor segments;
each said segment being connected to the next segment by mechanical means and electrical means;
said base plate having a plurality of holes;
said holes being use for water drainage and for mechanically fastening said segment;
said horizontal stems being used to support branches and holding lighting fixtures;
said tutor assembly having a series of connecting holes configured and sized to receive complementary configured and sized horizontal stem tips as well as lighting fixture tips;
said tutor assembly further having embedded wiring to provide DC power outlets.

2. A modular tutor system as in claim 1 wherein:
said horizontal stem having a plurality of hooking loops.

3. A modular tutor system as in claim 1 wherein:
an extension base plate into which can fit the base plate;
said extension base plate using a similar mechanical connecting means as for said segments.

4. A modular tutor system as in claim 1 wherein:
little footings disposed underneath said base plate to lift it up so as to help drain water.

5. A modular tutor system as in claim 1 wherein:
said base plate being made of heavy material so that it can firmly hold a plant in place.

6. A modular tutor system as in claim 5 wherein:
said heavy material being selected from the group comprised of but not limited to metal.

7. A modular tutor system as in claim 5 wherein:
said heavy material being selected from the group comprised of but not limited to concrete.

8. A modular tutor system as in claim 1 wherein:
said mechanical connecting means, preferably but not necessarily being by way of threads which can be of the <<¼ turn >> kind or <<screw >> type threads.

9. A modular tutor system as in claim 1 wherein:
said electrical connecting means, preferably but not necessarily male/female connectors (36, 36′) containing both polarities for carrying low voltage DC current.

10. A modular tutor system as in claim 1 wherein:
said connecting holes being used as water drainage means.

11. A modular tutor system comprising:
a stake, a tutor assembly, and horizontal stems;
said tutor assembly comprised of a plurality of tutor segments;
planted directly into the ground to start up said tutor assembly each said segment being connected to the next segment by mechanical means and electrical means;
said horizontal stems being used to support branches and holding lighting fixtures;
said tutor assembly having a series of connecting holes configured and sized to receive complementary configured and sized horizontal stem tips as well as lighting fixture tips;
said tutor assembly further having embedded wiring to provide DC power outlets;
said horizontal stem having a plurality of hooking loops.
said mechanical connecting means, preferably but not necessarily being by way of threads which can be of the <<¼ turn>> kind or <<screw>> type threads.
said electrical connecting means, preferably but not necessarily male/female connectors (36, 36′) containing both polarities for carrying low voltage DC current.
said connecting holes being used as water drainage means.

12. A modular tutor system as in claim 11 wherein:
said stake having stake threads.
